(19) United States
(12) Patent Application Publication
(10) Pub. No.: US 2007/0252445 A1
(43) Pub. Date: Nov. 1, 2007

(54) Linear motor, manufacturing method of the linear motor, and stage apparatus using the linear motor

(75) Inventors: Daisuke Shinohira, Nerima-ku (JP); Dotaro Usui, Kawasaki-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/822,001

(22) Filed: Jun. 29, 2007

Related U.S. Application Data
(63) Continuation of application No. PCT/JP05/24062, filed on Dec. 28, 2005.

(30) Foreign Application Priority Data
Jan. 27, 2005 (JP) 2005-020217

(51) Int. Cl. H02K 41/00

(52) U.S. Cl. 310/12

(57) ABSTRACT

A linear motor, includes a coil part having a plurality of coils forming a line; a magnetic yoke part having a plurality of permanent magnets facing the coil part; a cover member covering the coil part; and a coil cooling part formed inside the cover member and configured to cool the coil part by supplying cooling water; wherein the coil part has a structure where a resin material is formed on the circumferences of the coils and a glass film is formed on the resin material.

### CROSS-REFERENCE TO RELATED APPLICATION

This application is a U.S. continuation application filed under 35 USC 111(a) claiming benefit under 35 USC 120 and 365(c) of PCT application JP05/024062, filed Dec. 28, 2005, which claims priority to Application Ser. No. 2005-20217, filed in Japan on Jan. 27, 2005. The foregoing applications are hereby incorporated herein by reference.

### BACKGROUND OF THE INVENTION

1. Field of the Invention

The present invention generally relates to linear motors, manufacturing methods of the linear motors, and stage apparatuses using the linear motors. More particularly, the present invention relates to a linear motor wherein cooling water is supplied to a periphery of a coil so that adverse effects of heat generated by the linear motor are prevented, a manufacturing method of the linear motor, and a stage apparatus using the linear motor.

2. Description of the Related Art

In fine positioning apparatuses used for, for example, semiconductor manufacturing equipment or liquid crystal manufacturing equipment, a linear motor is used as a driving part configured to drive a stage where a processed subject such as a substrate is mounted. Both ends of the stage are driven in translation by a pair of linear motors.

Such a liner motor includes a coil part and a magnetic yoke part. Plural coils are arranged in a single line in the coil part. Plural permanent magnets are arranged in a single line so as to face the coil line in the magnetic yoke part. The coil part is energized so that an electromagnetic force is generated and a thrust force (driving force) is generated to act on the permanent magnet.

In addition, as the structure of the linear motor, there is a moving coil type and a moving magnet type. In the moving coil type, the magnetic yoke part works as a fixed side and the coil part works as a movable side. In the moving magnet type, the coil part works as a fixed side and the magnetic yoke part works as a movable side.

In either type, if temperature is increased due to heat from the coil, the resistance value of the coil itself is increased so that the driving current is reduced. In the linear motor, since the thrust force is proportional to the driving current, the thrust force is decreased as the driving current is decreased.

In addition, heat generated from the coil influences the external environment. Because of this, a cooling part is configured to cool the coil part in the linear motor in order to reduce the influence due to heat from the coil.

Japanese Laid-Open Patent Application Publication No. 2003-224961, for example, discloses a cooling part having a structure where a cooling tube is attached to a coil part and a coolant or pure water is supplied to the cooling tube so that the coil is cooled.

Furthermore, in the linear motor, there is demand for improved cooling efficiency of the coil. For example, plural coils are covered with a resin material where a holder and the circumference of the resin material are covered with a cover member, so that a cooling path is formed between the resin material and the cover member. Here, the cover member is, for example, made of a metal such as stainless, a resin material such as CFRP (Carbon Fiber Reinforced Plastic) strengthened by a carbon fiber, ceramics, or the like.

In this cooling structure, inactive coolant (fluoride group inactive liquid) is supplied to the cooling path so that heat of the coil is transferred by heat exchange with the inactive coolant.

While such an inactive coolant may not degrade the functioning of the linear motor itself and may not affect the insulating properties of the coil, since the specific heat of the coolant is relatively low, it is difficult to improve the cooling efficiency.

However, in the linear motor, the thrust force, namely a driving force, is generated by the flow of an electric current through a coil line. Therefore, in a case where larger thrust force is required or the moving speed of a movable part needs to be increased so that high speed moving is realized, an obstacle for fine positioning is generated. For example, the temperature of the coil is increased so that properties of the linear motor itself may be degraded. Alternatively, a fine positioning apparatus, for example a measuring apparatus such as a laser interferometer in semiconductor device manufacturing equipment may be adversely influenced. Furthermore, a structural member supporting the movable part may be deformed due to change of temperature.

There is demand for improving the cooling efficiency to prevent such an increase of the temperature of the coil. For example, in the above-discussed cooling structure of the coil, the use of water having specific heat higher than that of the inactive coolant has been examined.

However, in a case where water is supplied to the cooling path formed between the resin material and the cover member so that the cooling efficiency is improved, the water may penetrate into the resin material covering the coil so that dielectric breakdown may happen. In addition, moisture is vaporized and expanded due to heat generation so that stress concentrating on an edge surface exceeds the resin strength so that crack may be generated in the resin, or a resin element or metal ions may be dissolved.

### SUMMARY OF THE INVENTION

Accordingly, embodiments of the present invention can provide a novel and useful linear motor, manufacturing method of the linear motor, and stage apparatus using the linear motor, in which one or more of the problems described above are eliminated.

More specifically, the embodiments of the present invention can provide a linear motor including: a coil part having a plurality of coils forming a line; a magnetic yoke part having a plurality of permanent magnets facing the coil part; a cover member covering the coil part; and a coil cooling part formed inside the cover member and configured to cool the coil part by supplying cooling water; wherein the coil part has a structure where a resin material is formed on the circumferences of the coils and a glass film is formed on the resin material.

The embodiments of the present invention can also provide a manufacturing method of a linear motor, including: a first step of arranging plural coils in a line; a second step of forming a resin material on the circumferences of the coils; a third step of forming a glass film on the surface of the resin material; a fourth step of covering the circumference of the glass film with a cover member forming a cooling water flow path where cooling water is supplied; a fifth step of providing a lead line path to an inside of an edge part of the cover member, the lead line path being configured to lead lead lines led from the coils; and a sixth step of attaching a magnetic yoke part having plural permanent magnets to the coil part so that the magnetic yoke part faces the coil part.

The embodiments of the present invention can also provide a stage apparatus, including the above-mentioned linear motor.

Other objects, features, and advantages of the present invention will become more apparent from the following detailed description when read in conjunction with the accompanying drawings.

### BRIEF DESCRIPTION OF THE DRAWINGS

FIG. 1 is a plan view of a stage apparatus where an example of a linear motor of an embodiment of the present invention is applied;

FIG. 2 is a perspective view showing a structure of a linear motor 20;

FIG. 3A is a vertical cross-sectional view of a coli part 60 and shows an internal structure of the coil part 60;

FIG. 3B is an enlarged cross-sectional view of a part A of FIG. 3A and shows the internal structure of the coil part 60;

FIG. 4 is a perspective view showing a state where two lines of coils 66 are provided so as to form lines;

FIG. 5 is a right side view of the coil part 60;

FIG. 6A is a vertical cross-sectional view taken along line V-V of FIG. 5 and shows an inside of the coil part 60;

FIG. 6B is an enlarged cross-sectional view of a part B of FIG. 6A and shows the inside of the coil part 60;

FIG. 7 is an enlarged cross-sectional view of a part A of a modified example 1; and

FIG. 8 is an enlarged cross-sectional view of a part A of a modified example 2.

### DETAILED DESCRIPTION OF THE PREFERRED EMBODIMENT

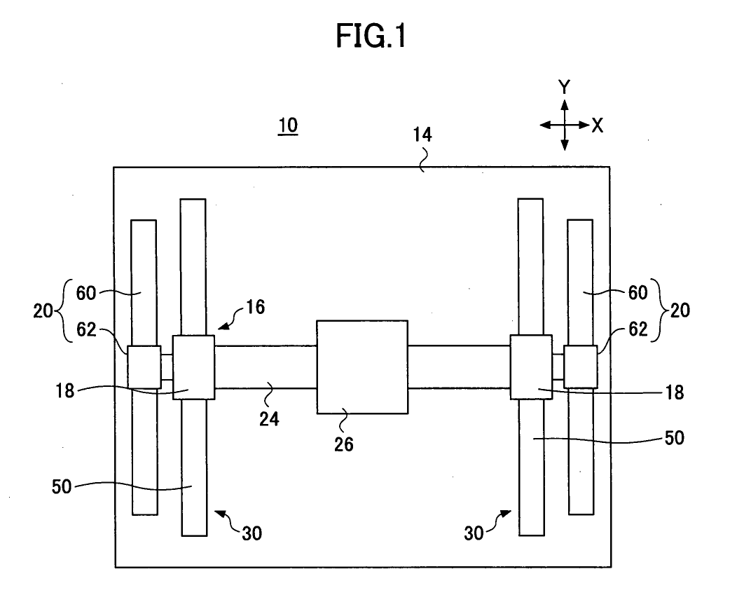

A description will now be given, with reference to FIG. 1 through FIG. 8, of embodiments of the present invention.

[First Example]

FIG. 1 is a plan view of a stage apparatus where an example of a linear motor of an embodiment of the present invention is applied. As shown in FIG. 1, a stage apparatus 10 is a XY stage. The stage apparatus 10 includes a base 14, a movable part 16, and a pair of linear motors 20. The base 14 is fixed to a concrete base (not shown). The movable part 16 is moved on the base 14. The linear motors 20 drive corresponding end parts of the movable part 16 in directions indicated by arrows Y.

The movable part 16 includes sliders 18, a Y slider 24, and an X slider 26. The sliders 18 are driven by the linear motors 20. The Y slider 24 extends in directions indicated by arrows X perpendicular to a moving direction so as to connect the sliders 18. The X slider 26 moves on the Y slider 24 in the directions indicated by the arrows X.

The sliders 18 are guided by guide rails 50 of guide parts 30 extending in the directions indicated by the arrows Y and slidably supported in the directions indicated by the arrows Y. The movement of the sliders 18 in the directions indicated by the arrows Y is controlled by thrust forces (driving forces) from the liner motors 20 as driving parts.

While the sliders 18 provided at left and right ends are guided by the guide parts 30, the movable part 16 is driven in the directions indicated by the arrows Y by the driving force of the linear motor 20. In addition, each of the linear motors 20 is controlled so as to generate the same driving force as the other and thereby the sliders 18 arranged one at each end of the Y-sliders 24 are driven in translation.

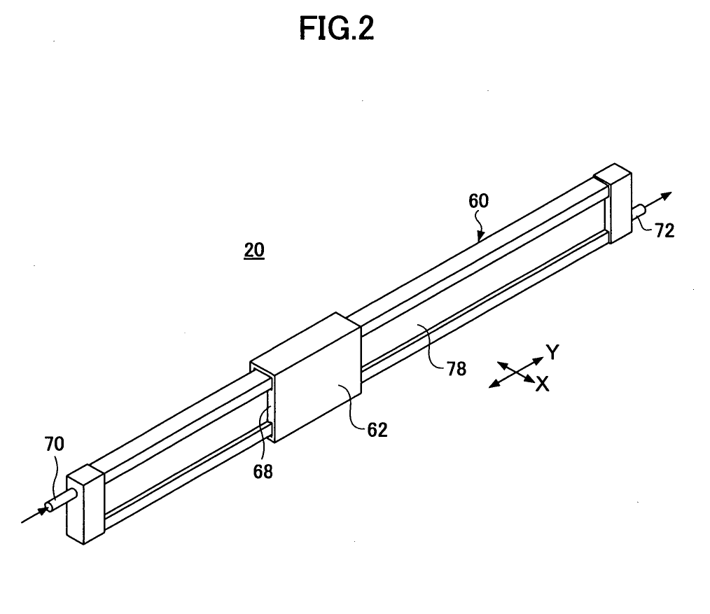

Here, the structure of the linear motor 20 is discussed with reference to FIG. 2. FIG. 2 is a perspective view showing the structure of a linear motor 20. As shown in FIG. 2, the linear motor 20 is an MM type (moving magnet type) and includes a coil part 60 and a magnetic yoke part 62.

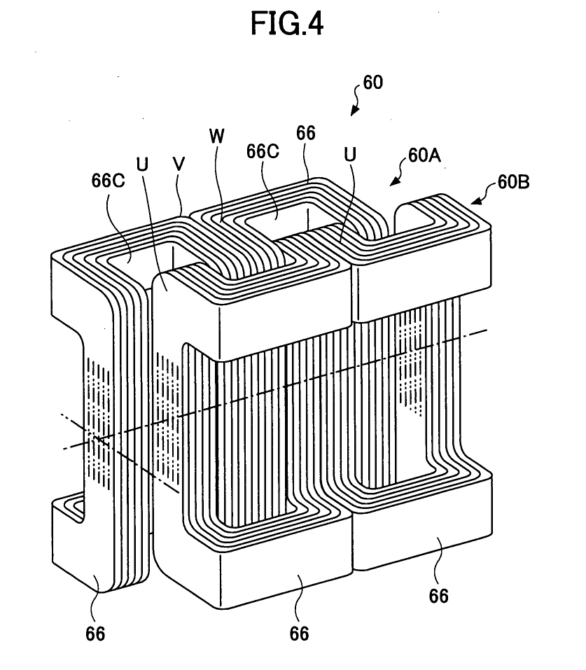

The coil part 60 is fixed on a base 14. As discussed below with reference to FIG. 4, in the coil part 60, plural coils 66 are arranged in line.

The magnetic yoke part 62 moves in a direction where the coil part 60 extends. The magnetic yoke part 62 includes a permanent magnet 68.

The coil 66 of the coil part 60 is arranged so as to face the permanent magnet 68. The coil 66 generates a driving force, namely a thrust force in the directions indicated by the arrows Y with the permanent magnet 68 by applying a driving voltage.

Therefore, a Lorentz force to the permanent magnet 68 is generated from the coil part 60 so that the linear motor 20 applies a driving force in the directions indicated by the arrows Y to the slider 18. The linear motor 20 can generate the driving force so that the slider 18 can run at a constant speed in the directions indicated by the arrows Y by controlling a voltage applied to the coil 66 of the coil part 60.

A cooling water supply opening part 70 is provided at an upper part of a front end of the coil part 60 so that cooling water for cooling the coil 66 is supplied. A cooling water discharge opening part 72 is provided at a lower part of a rear end of the coil part 60 so that the cooling water is discharged. Accordingly, the cooling water supplied from the cooling water supply opening part 70 flows down in a rear direction (Y direction) so as to be discharged from the cooling water discharge opening part 72.

A cooling water flow path 74 is formed inside the coil part 60. The cooling water supplied from the cooling water supply opening part 70 pushes out cooling water filling the entire cooling water flow path in the rear direction (Y direction) and exchanges heat during the flow so as to receive heat from each of the coils 66.

In this example, as the cooling water, city water containing chlorine or pure water where impurities are removed may be used. In addition, since the cooling water has specific heat higher than that of the inactive coolant, heat generated from the coil 66 can be sufficiently transferred with high cooling efficiency. Because of this, in a case where the thrust force (driving force) of the linear motor 20 is increased or the slider 18 is moved at a high speed, the temperature from the coil 66 may be increased. However, by supplying the cooling water to the cooling water flow path 74, it is possible to cool more effectively than a conventional cooling way using the inactive coolant.

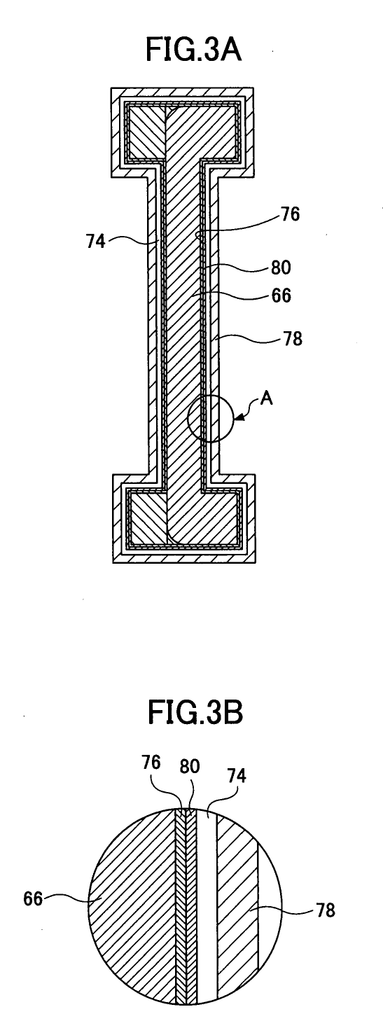

FIG. 3A is a vertical cross-sectional view of the coil part 60 and shows an internal structure of the coil part 60. FIG. 3B is an enlarged cross-sectional view of a part A of FIG. 3A and shows the internal structure of the coil part 60.

As shown in FIG. 3A and FIG. 3B, in the coil part 60, two lines of the coil 66 unified by a resin material 76 are covered with a cover member 78. A glass film 80 is formed on a surface of the resin material 76. Since the glass film 80 is an inorganic material, the glass film 80 has insulating properties and water penetration can be prevented.

The cooling water flow path 74 where the cooling water flows is formed in a gap between an internal wall of the cover member 78 and a surface of the glass film 80. The cover member is made of a stainless material, a resin material or ceramics.

The glass film 80 can have uniform thickness (several microns) by coating a liquefied glass material called liquid glass. In addition, by using a liquid coating material called glass coat material, coating at a normal temperature can be performed and therefore it is possible to easily form the glass film 80. Thus, by covering the entire surface of the coil 66 with the glass film 80, it is possible to prevent the cooling water flowing along the cooling water flow path 74 from penetrating to a coil 66 side. Because of this, it is possible to prevent dielectric breakdown due to the cooling water or elution of metal ion or the insulation material of the coil surface.

It may be preferable to use quartz glass as the glass film 80. Furthermore, since it is possible to form a solid glass film completely different from a silica film at a relatively low temperature by using the glass coat material, its manufacturing method is easy. Therefore, the glass film 80 having sufficient strength can be coated on the entire surface of the resin material 76 at a low temperature.

FIG. 4 is a perspective view showing a state where two lines of coils 66 are provided so as to form lines. As shown in FIG. 4, in the coil part 60, two coil lines 60A and 60B are arranged so as to face each other in 180 degrees different direction. In each of the coil line 60A and 60B, two coils 66 are arranged in a moving direction (Y direction). Both end sides of each of the coils 66 are bent at 90 degrees so that each of the coils 66 has a U configuration of a rectangle without one side. The coil 66 of the first coil line 60A is engaged with the coil 66 of the second coil line 60B.

Therefore, a linear part 66A of the coil 66 of the first coil line 60A is engaged with a concave part 66C of the coil 66 of the second coil line 60B. A linear part 66A of the coil 66 of the second coil line 60B is engaged with a concave part 66C of the coil 66 of the first coil line 60B. The linear part 66A of the coil 66 of the first coil line 60A and the linear part 66A of the coil 66 of the second coil line 60B are overlapped. In addition, since plural coils 66 are controlled by three phases, namely a U phase, a V phase, and a W phase, two lead lines are led out from each of the phases.

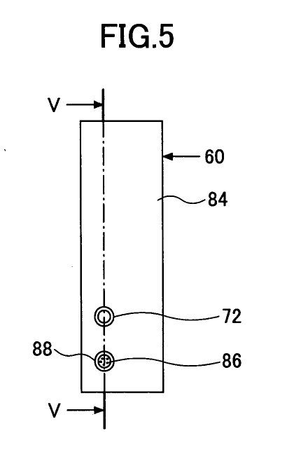

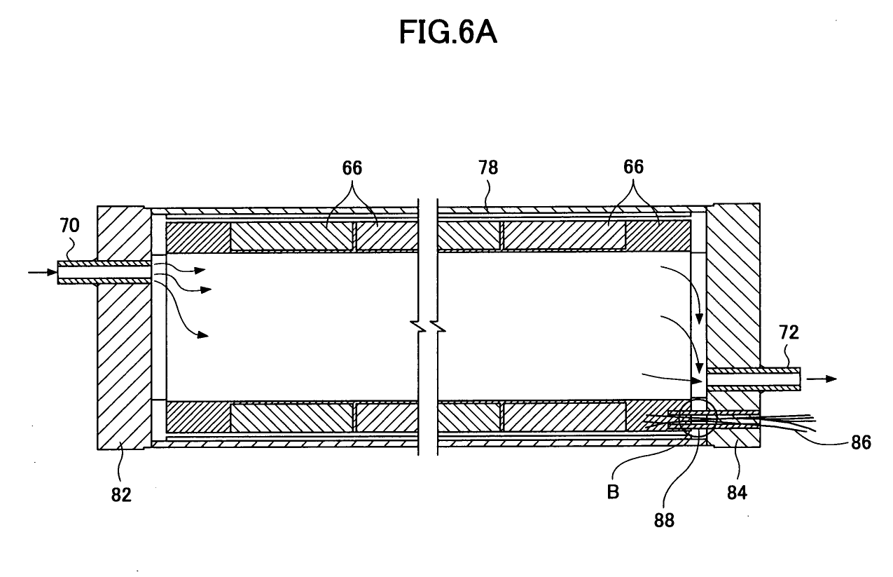

FIG. 5 is a right side view of the coil part 60. FIG. 6A is a vertical cross-sectional view taken along line V-V of FIG. 5 and shows the inside of the coil part 60. FIG. 6B is an enlarged cross-sectional view of a part B of FIG. 6A and shows the inside of the coil part 60.

As shown in FIG. 5, FIG. 6A, and FIG. 6B, in the coil part 60, rectangular shaped blocks 82 and 84 are engaged and fixed to corresponding ends of the cover material 78 where plural coils 66 are received. In a case where the cove material 78 and the blocks 82 and 84 are formed by metal materials such as stainless or the like, engaging parts are formed by welding so that a sealed structure is made.

The cooling water supply opening part 70 pierces the block 82 and the cooling water discharge opening part 72 pierces the block 84. The cooling water supply opening part 70 and the cooling water discharge opening part 72 are made of metal pipes and entire external circumferences of the cooling water supply opening part 70 and the cooling water discharge opening part 72 are connected to the blocks 82 and 84, respectively, by welding so that a sealed structure is made.

Six lead lines 86 of the corresponding coils 66 are inserted in a lead line guide member 88 so as to be led out to the outside. The lead line guide member 80 is made of a metal pipe such as a stainless pipe. One end of the metal pipe is inserted in the coil 66 side and the other end of the metal pipe pierces the block 84.

In addition, the liquid glass is coated on the external circumference of the lead line guide member 88 having an inside where lead line paths are situated, and the glass film 89 is formed on the entire external circumference of the lead line guide member 88. Because of this, it is possible to prevent the cooling water from penetrating the lead line guide member 88 due to the glass film 89. Hence, it is possible to prevent dielectric breakdown of the lead line 86 due to the cooling water or elution of metal ions or the insulation material of the coil surface.

Here, process steps of a manufacturing method of the linear motor 20 are discussed.

In step 1, as shown in FIG. 4, plural coils 66 are arranged in line.

Next, in step 2, lead lines 86 led out from the coils 66 are inserted in the lead line guide member 88. In step 3, as shown in FIG. 3A and FIG. 3B, the resin material 76 is formed on the circumferences of plural coils 66.

Then, the liquid glass is coated on the surface of the resin material 76 so that the glass film 80 is formed in step 4. See FIG. 3A and FIG. 3B. In step 5, the circumference of the glass film 80 is covered with the cover member 78 forming the cooling water flow path 74 where the cooling water is supplied. See FIG. 3A and FIG. 3B.

After that, the lead line guide member 88 where the lead lines 66 are inserted is provided at an inside of an edge part of the cover member 78. See FIG. 6A and FIG. 6B. In step 7, the blocks 82 and 84 are connected to corresponding ends of the cover member 78 by welding.

Finally, in step 8, as shown in FIG. 2, the magnetic yoke part 62 having plural permanent magnets 68 is slidably attached to the coil part 60 so that the magnetic yoke part 62 faces the coil part 60.

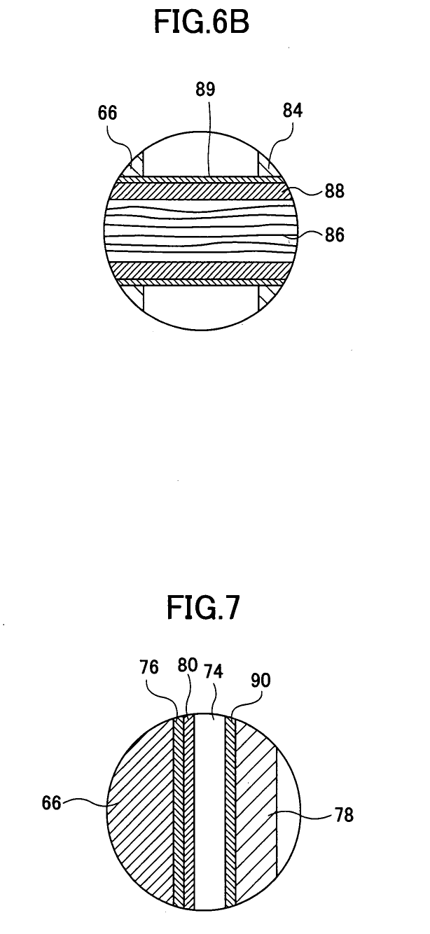

FIG. 7 is an enlarged cross-sectional view of a part A of a modified example 1. As shown in FIG. 7, in the modified example 1, the glass film 90 is coated on even an internal surface of the cover member 78. Because of this, it is possible to prevent elution of metal ions from the cover member 78 due to the cooling water.

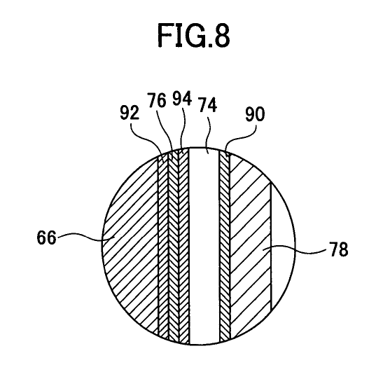

FIG. 8 is an enlarged cross-sectional view of a part A of a modified example 2. As shown in FIG. 8, in the modified example 2, a first glass film 92 is coated on the circumferences of plural coils 66 and the resin material 76 is molded on the surface of the first glass film 92. A second glass film 94 is coated on a surface of the resin material 76. Because of this, in the modified example 2, penetration of the cooling water can prevented by double glass films 92 and 94. Therefore, it is possible to prevent generation of cracks or dielectric breakdown by the cooling water or elution of metal ions or the insulation material of the coil surface and therefore durability is improved.

The present invention is not limited to these embodiments, but variations and modifications may be made without departing from the scope of the present invention.

For example, although the linear motor used for the stage apparatus is explained in the above-discussed embodiment, the present invention is not limited to this. The present invention can be applied to a linear motor uses as a driving part of other apparatus.

In addition, although the MM (Moving Magnet) type linear motor is explained in the above-discussed embodiment, the present invention is not limited to this. The present invention can be applied to, for example, an MC (Moving Coil) type linear motor.

Thus, according to the above-discussed embodiments of the present invention, it is possible to provide a linear motor, including: a coil part having a plurality of coils forming a line; a magnetic yoke part having a plurality of permanent magnets facing the coil part; a cover member covering the coil part; and a coil cooling part formed inside the cover member and configured to cool the coil part by supplying cooling water; wherein the coil part has a structure where a resin material is formed on the circumferences of the coils and a glass film is formed on the resin material.

According to the above-mentioned linear motor, it is possible to cool the coil efficiently by supplying the cooling water. In addition, it is possible to prevent penetration of the cooling water to the coil and the resin material due to the glass film, generation of crack or dielectric breakdown due to the cooling water, and elution of metal ion or the insulation material of the coil surface.

A glass film may be formed on an internal surface of the cover member.

According to the above-mentioned linear motor, it is possible to prevent elution of metal ions from the cover member due to the cooling water.

The coil part may have a structure where a first glass film is formed on the circumferences of the coils, a resin material is formed on the surface of the first glass film, and a second glass film is formed on the surface of the resin material.

According to the above-mentioned linear motor, it is possible to prevent penetration of the cooling water by using double glass films, and elution of metal ions or the insulation material of the coil surface due to the cooling water.

The coil part may include a lead line path configured to lead lead lines led from plural coils to an outside of the cover member; and glass films may be formed on an external circumference of the lead line path.

According to the above-mentioned linear motor, it is possible to prevent penetration of the cooling water into the lead line, and elution of metal ions or the insulation material from the lead line due to the cooling water.

The cooling water may be pure water. The glass film may be made of quartz glass.

According to the above-discussed embodiments of the present invention, it is also possible to provide a manufacturing method of a linear motor, including: a first step of arranging plural coils in a line; a second step of forming a resin material on the circumferences of the coils; a third step of forming a glass film on the surface of the resin material; a fourth step of covering the circumference of the glass film with a cover member forming a cooling water flow path where cooling water is supplied; a fifth step of providing a lead line path to an inside of an edge part of the cover member, the lead line path being configured to lead lead lines led from the coils; and a sixth step of attaching a magnetic yoke part having plural permanent magnets to the coil part so that the magnetic yoke part faces the coil part.

According to the above-discussed embodiments of the present invention, it is also possible to provide a stage apparatus, including the above-mentioned linear motor.

What is claimed is:

1. A linear motor, comprising:
a coil part having a plurality of coils forming a line;
a magnetic yoke part having a plurality of permanent magnets facing the coil part;
a cover member covering the coil part; and
a coil cooling part formed inside the cover member and configured to cool the coil part by supplying cooling water;
wherein the coil part has a structure where a resin material is formed on the circumferences of the coils and a glass film is formed on the resin material.

2. The linear motor as claimed in claim 1,
wherein a glass film is formed on an internal surface of the cover member.

3. The linear motor as claimed in claim 1,
wherein the coil part has a structure where a first glass film is formed on the circumferences of the coils, a resin material is formed on the surface of the first glass film, and a second glass film is formed on the surface of the resin material.

4. The linear motor as claimed in claim 1,
wherein the coil part includes a lead line path configured to lead lead lines led from plural coils to an outside of the cover member; and
glass films are formed on an external circumference of the lead line path.

5. The linear motor as claimed in claim 1,
wherein the cooling water is pure water.

6. The linear motor as claimed in claim 1,
wherein the glass film is made of quartz glass.

7. A manufacturing method of a linear motor, comprising:
a first step of arranging plural coils in a line;
a second step of forming a resin material on the circumferences of the coils;
a third step of forming a glass film on the surface of the resin material;
a fourth step of covering the circumference of the glass film with a cover member forming a cooling water flow path where cooling water is supplied;
a fifth step of providing a lead line path to an inside of an edge part of the cover member, the lead line path being configured to lead lead lines led from the coils; and
a sixth step of attaching a magnetic yoke part having plural permanent magnets to the coil part so that the magnetic yoke part faces the coil part.

8. A stage apparatus, comprising:
the linear motor claimed in claim 1 as a driving part.

9. A stage apparatus, comprising:
the linear motor claimed in claim 2 as a driving part.

10. A stage apparatus, comprising:
the linear motor claimed in claim 3 as a driving part.

11. A stage apparatus, comprising:
the linear motor claimed in claim 4 as a driving part.

12. A stage apparatus, comprising:
the linear motor claimed in claim 5 as a driving part.
